(19) United States
(12) Patent Application Publication
(10) Pub. No.: US 2020/0356595 A1
(43) Pub. Date: Nov. 12, 2020

(54) TECHNICAL DOCUMENT SEARCHING APPARATUS AND METHOD OF SEARCHING TECHNICAL DOCUMENT

(71) Applicant: WEVELOP CO., LTD., Seoul (KR)

(72) Inventors: Kwon Seok KIM, Seoul (KR); Hyun Kyung CHAI, Seoul (KR)

(73) Assignee: WEVELOP CO., LTD.

(21) Appl. No.: 16/801,415

(22) Filed: Feb. 26, 2020

(30) Foreign Application Priority Data
Feb. 27, 2019 (KR) 10-2019-0023499
Apr. 17, 2019 (KR) 10-2019-0045039
Sep. 16, 2019 (KR) 10-2019-0113776

(51) Int. Cl. G06F 16/908; G06F 16/903; G06F 16/93; G06F 16/9038

(52) U.S. Cl. CPC G06F 16/908; G06F 16/90335; G06F 2216/11; G06F 16/9038; G06F 16/94

(57) ABSTRACT

The present invention relates to a technology literature searching application apparatus and a patent search method using the same. The technology literature searching application apparatus using a treatise link search according to an embodiment of the present invention may comprise: an interface unit for receiving the search information from a client terminal, a first subject treatise search unit for searching a first subject treatise data from the search information, a citation relationship treatise search unit for obtaining a target treatise data having a forward or backward citation relationship with a predetermined first subject treatise data, or target treatise information about the target treatise data, from the citation relationship information of the searched first subject treatise data, and a target patent search unit for searching a target patent literature related to the target treatise data or the target treatise information.

### CROSS-REFERENCES TO RELATED APPLICATION

The present application claims the benefit of Korean applications No. 10-2019-0023499 filed on Feb. 27, 2019, No. 10-2019-0045039 filed on Apr. 17, 2019, and No. 10-2019-0113776 filed on Sep. 16, 2019, which are all herein incorporated by reference in its entirety.

### BACKGROUND OF THE INVENTION

### 1. Field

The present invention relates to a literature search technology, and more particularly, to a technical document search application apparatus and a method of searching technical document.

### 2. Description of the Related Art

When researching a technology or developing a product, the technology of other research groups may be surveyed, or the literature such as technical article may be examined to understand a current state of development of the related technology and a flow of technology development in order to prevent a duplicated research and development. In particular, the technologies that are highly likely to be commercialized are protected by patent rights, and therefore a prior art search for patents may be conducted before commercializing the technologies.

Various search techniques have been developed and utilized for the aforementioned literature research. Much efforts have been made for efficient data search via a method for classifying components of data by using data mining technology according to the degree to which they are directly or indirectly related, a method for extracting keywords and generating specific variables by using the extracted keywords, development of a patent search apparatus for generating search formular by using a patent classification and patent classification database.

In addition, in the conventional method of extracting keywords or patent search apparatus using the patent classification and patent classification database, as keywords that are common to invention or technology to be searched are more, patents documents only having high relevance are searched. Therefore, unless the related search results are processed additionally, there is a limitation that information such as trend of commercialization in the technological field or the trend of technological commercialization of a competitive research organization is not found directly from the search results.

In addition, in order to understand the technology trend, it is important to search an adjacent technology or a competitive technology such as alternative technology and design around technology as well as a target technology to be searched, and it is also desirable to search for institutions or companies that may commercialize the target technology to be searched. Since most of the institution or the companies are also interested in the adjacent technology or the competitive technology, it is desirable to employ a searching system to distinguish and search the adjacent technology or the competitive technology without being limited to keywords related to the searched target technology in the prior patent research.

### SUMMARY OF THE INVENTION

The technological object of the present invention is to provide a technology literature searching application which may grasp adjacent technology or competitive technology of target technology, grasp technology and research trends of competitive companies or competitive researchers who are interested in the target technology, and identify precisely and easily related organizations or companies that may be surveyed for commercialization of the target technology, in order to maximize value in use of the searched documents without being limited to the contents of the target technology to figure out the prior art.

Another object of the present invention is to provide a technology literature searching application which may identify trends in a target technology and major players without repeated many searching, when searching the technological fields of interest to which a particular inventor, a researcher, an institution or a company is paying keen attention, or when searching for an institution, a company or a competitor that is interested in a particular technology.

In addition, the technological object of the present invention is to provide a technology literature searching method having the above-described advantages, which minimizes data processing by shortening searching time, and determines types of technology without errors, while having a high accuracy.

The technology literature searching application apparatus according to an embodiment of the present invention for solving the above problems is a technology literature searching application apparatus using the treatise link search, and may comprise: an interface unit for receiving the search information from a client terminal; a first subject treatise search unit for searching a first subject treatise data from the search information; a citation relationship treatise search unit that obtains a target treatise data having a citation relationship or a quotation relationship with a predetermined first subject treatise data, or target treatise information about the target treatise data, from the citation relationship information of the searched first subject treatise data; and a target patent search unit for searching for target patent literatures related to the target treatise data or the target treatise information. In other example, the predetermined first subject treatise may be all of the first subject treatises or may be determined by a predetermined criteria or a user's selection.

In an example, the citation relationship treatise search unit may assign a weight value to the target patent literature according to the number of times of quotation of the first subject treatise or the target treatise data. In other example, the citation relationship treatise search unit may assign a weight value to the target patent literature according to a citation position where the target treatise data cites or quotes the first subject treatise data. In an embodiment, the citation position may be one or more of an abstract, an introduction, a discussion, an experimental example, or a measurement. In other example, the citation relationship treatise search unit defines the treatise data directly citing/quoting the predetermined first subject treatise data as the first generation citation/quotation treatise data, and defines a treatise data indirectly citing/quoting the predetermined first subject treatise data as a second generation citation/quotation data by citing/quoting the first generation citation/quotation treatise data. When a treatise data indirectly citing/quoting the first subject treatise data is designated as the nth-generation citation/quotation treatise data by citing/quoting the n-1th generation citation/quotation treatise data, the citation relationship treatise search unit may further include a nth citation generation setting unit which sets the target treatise data as the nth generation citation/quotation treatise data by specifying a predetermined n value for searching.

In an example, the target treatise information may include at least one or more of a title and an author of the target treatise, the first author of the treatise, an affiliated institution of the author or the first author, a link to the treatise site, an abstract, keywords, a main text, a piece of information of a sponsoring organization, an open researcher and contributor ID(ORCID), the names of society and journal, a publication date, a digital object identifier(DOI), an international standard serial registration number(ISSN), a CAS registration number, the automatic recommendation keywords added by the citation relationship treatise search unit, synonyms of the automatic recommendation keywords, deep-learning, artificial intelligence(AI), or frequent statements of the treatise data. In other example, the target patent literature may include at least one or more of the target treatise information.

In an embodiment, the target patent search unit may search for a target patent literature including at least one or more of the target treatise information in a target field initially set or selected by a user. In other example, the target patent search unit may search for target patent literatures related to all of the target treatise data, or target patent literatures related to a predetermined target treatise data determined by a predetermined criteria or a user's selection among the target treatise data.

In other example, the target patent search unit may comprise a first limit search unit configured to search for only the target patent literature considered as being filed within a grace period of a publication exception assertion of the target treatise data; or a second limit search unit configured to search for only the target patent literature filed within a previous period limit or a subsequent period limit from on a filing date or publication date of the target treatise data.

A patent application apparatus according to an embodiment of the present invention may further include a patent technology analysis unit for generating technology analysis information including at least one or more of an applicant change of the target patent literature, existence of joint application, an ownership transfer, existence of license establishment, succession identification information of an application right, co-applicant identification information, an assignee identification information, a licensee identification information, a remaining period, a filing date, a number of family applications, a country information, or existence of a patent dispute. In other example, the patent technology analysis unit may configure the technology analysis information in time series. In yet another embodiment, the patent technology analysis unit may classify the first subject treatise data, the target treatise data, or the target patent literature according to any one of inventors, applicants, current right owners, authors, or affiliated organizations of the authors. In other example, the patent technology analysis unit may classify the target patent literature as a competitive technology when the target treatise data cites the first subject treatise data, and may classify the target patent literature as a technology on which may be infringed when the first subject treatise data cites the target treatise data.

A patent application apparatus according to an embodiment of the present invention may further include a user communication unit configured to output identification information of a searched treatise data or patent literatures, an original text file or the treatise data, information of patent literatures, or a combination thereof, and may include the searched treatise data, the first subject treatise data, the target treatise data or the target patent literature.

According to another embodiment for solving the above problems, a technology literature searching application apparatus using the treatise link search may comprise an interface unit for receiving search information from a client terminal; a target patent search unit for obtaining target patent literature and target patent literature information about the target patent literature from the search information; a second subject treatise search unit for searching second subject treatises related to the target patent from the target patent literature information; a citation relationship treatise search unit for obtaining target treatise data having a citation relationship or a quotation relationship with a predetermined second subject treatise, or target treatise information about the target treatise data, from the citation relationship information of the searched second subject treatises; and a target patent search unit for searching for target patent literatures related to the target treatise data or the target treatise information. In an example, the target patent literature may include a patent literature obtained from the search information or a patent literature in a citation relationship or a quotation relationship with the target patent literature. In other example, the search information may be assigned to a name, summary, an applicant, a detailed description, an inventor, an IPC code, an application date, a publication date, a registration date, an application number, a publication number, a notification number, an agent or a combination thereof of an invention. In other example, the second subject treatise search unit may search for the second subject treatise having the same author as the inventor or the applicant of the target patent literature information.

According to an embodiment of the present invention for achieving the above objects, there is provided a patent search method through a treatise link search may comprise a step receiving search information from a client terminal; a step for searching for first subject treatise data from the search information; a step for obtaining a target treatise data having a citation relationship or a quotation relationship with a predetermined first subject treatise data among the first subject treatise data, or target treatise information about the target treatise data; and a step for searching a target patent literature related to the target treatise data or the target treatise information.

In accordance with another embodiment of the present invention of the present invention for achieving the above objects, there is provided a patent search method through a treatise link search may comprises: a step for receiving search information from a client terminal; a step for obtaining a target patent literature from the search information, and target patent literature information about the target patent literature; a step for searching second subject treatises related to the target patent from the target patent literature information; a step for obtaining a target treatise data having a citation relationship or a quotation relationship with a predetermined second subject treatise data among the second subject treatise data or target treatise information about the target treatise data; and a step for searching a target patent literature related to the target treatise data or the target treatise information.

The technology literature searching application apparatus according to an embodiment of the present invention may search the first target treatise data from the input search information, and search the target treatise data by using citation or quotation relationship of the first subject treatise data. Therefore, without being limited to contents of the previously searched information, it is possible to grasp adjacent technological field and/or competitive technological field to which the treatises citing or quoting the first subject treatise belong. Further, based on citation or quotation of the treatises, it is possible to easily determine whether the technologies of the target patent literature related to the treatises are techniques of a design around, or techniques to be possible to infringe the search target technique.

According to another embodiment of the present invention, a technology literature searching apparatus searches for a target patent from the search information, and searches for a second subject treatise through the target patent, inputs the bibliographic information such as an inventor, an applicant, a research institute, or a research company (hereinafter, referred to as a research entity) in the search information. Therefore, searching the research technology of the research entity, the related technologies of the research techniques, and/or the adjacent technologies to the research technology may be performed via a single search. Consequently, the research direction of the research entity may be consulted. If the research entity is a competitor, it may be applied to a portfolio construction by understanding searched patent literatures or treatise of the competitor.

A technology literature searching method according to another embodiment of the present invention, it is possible to shorten the search time, and provide very high accuracy as well as the above-described advantages by using the citing or cited relationship of the treatises.

### BRIEF DESCRIPTION OF THE DRAWINGS

FIG. 1 is a diagram illustrating a technology literature searching system according to an embodiment of the present invention

FIG. 2 is a diagram illustrating a technology literature searching application apparatus according to an embodiment of the present invention.

FIG. 3 is an output screen displayed on the client terminal by the user communication unit of the technology literature searching application apparatus according to an embodiment of the present invention.

FIG. 4 is an exemplary diagram illustrating a technology analysis method of a patent technology analysis unit according to an embodiment of the present invention.

FIG. 5 is an exemplary diagram illustrating a technology analysis method of the patent technology analysis unit according to another embodiment of the present invention.

FIG. 6 is a diagram illustrating a technology literature searching application apparatus according to another embodiment of the present invention.

FIG. 7 is a flowchart illustrating a patent search method according to an embodiment of the present invention.

FIG. 8 is a flowchart illustrating a patent search method according to another embodiment of the present invention.

### DETAILED DESCRIPTION OF THE INVENTION

Hereinafter, the preferred embodiments of the present invention will be described in detail with reference to the accompanying drawings.

The embodiments of the present invention are provided to more completely explain the present invention to those having a common knowledge in the related art, and following embodiments may be modified in various other forms, and the scope of the present invention is not limited to following embodiments. Rather, these embodiments are provided so that this disclosure may be faithfully and completely described, and the concepts of the invention may be completely conveyed to those skilled in the art.

In the drawings, the same reference numerals refer to the same elements. In addition, as used herein, the term, “and/or” includes any one, and all combinations of one or more of the listed items.

The terminology used herein is used for the purpose of describing particular embodiments and is not intended to be limiting the present invention. Although an expression in the present specification is described as a singular form, the singular form may include the plural forms as well, unless the context clearly indicates otherwise. Also, as used herein, the term, “comprise” and/or “comprising” specifies the stated shapes, numbers, steps, operations, members, elements and/or presence of these groups, and it is not intended to exclude the presence or addition of one or more other shapes, numbers, operations, members, elements and/or presence of these groups.

The reference herein to a layer formed “on” a substrate or other layer refers to a layer formed directly on the substrate or other layer, or formed on an intermediate layer formed on the substrate or other layer, or a layer formed on the intermediate layers. It may also refer to a layer. Also, for those skilled in the art, a structure or shape disposed “adjacent” to another shape may have the portions that overlap or are disposed below the adjacent shape.

In this specification, the relative terms such as “below”, “above”, “upper”, “lower”, “horizontal” or “vertical” may be used to describe the relationship that one constituent member, one layer or one region may be used to describe the relationship with other constituent members, layers or regions, as shown in the figures. It is to be understood that these terms encompass not only the directions indicated in the figures, but also other directions of the apparatus.

Hereinafter, the embodiments of the present invention will be described with reference to cross-sectional views schematically showing ideal embodiments (and intermediate structures) of the present invention. In these drawings, for example, the size and shape of the members may be exaggerated for convenience and clarity of description, and in actual implementation, variations of the illustrated shape may be expected. Accordingly, the embodiments of the invention should not be construed as limited to the specific shapes of the regions shown herein. Also, the reference numerals of members in the drawings refer to the same members throughout the drawings.

As used herein, the term, ‘data’ refers to a printed hard copy of a document (or literature, treatise), a soft copy, text or image which is a digital version of the document, and is a concept that includes not only a copy, but also an original in digital form or in printed form. Thus, the treatise data may be a published treatise or a file in the form of a digital document such as Adobe's PDF or Microsoft's DOC, which requires a media such as a computer as a non-limiting example. Similarly, a patent data may be a file in the form of a digital document such as PDF or DOC as well as a printed publication or notice.

As used herein, the term, ‘information’ is any digital value in various forms, such as text, audio, and video, which is stored and materialized in a database, and then may be called, identified, searched, or modified through query and computer-executable instructions. For example, the ‘treatise information’ may be a every item constituting the treatise data. That is, it may be bibliographic items such as identification information, title, author(s), related research institutions to which the author belongs, or cooperates with or sponsors the author in relation to the research topic of the treatise data, the publishing institution of the treatise data, titles of journals, publication dates, and digital object identifiers (DOIs), technology information such as the title, abstract, keywords, introduction or background, discussion, experimental examples, measurement examples, summary, conclusion, or application, or a portion such as citation (or, citing or cited relationship/forward or backward citation relationship, hereinafter term “citation” will be commonly used) information, and the treatise information may be in any form of data such as text, formulas, images, graphs, and multimedia or may include metadata of the treatise. Similarly, the term, ‘patent information’ refers to bibliographic information may be every item constituting the patent data. For example, it may be data of any form which indicates bibliographic information such as the filing date, publication date, registration date, inventor(s), applicant(s), patentee(s), information on a family application, or country of filing; and text, formulas, images, graphs and multimedia corresponding to the technology information of the invention such as the field of an invention, a background art, a summary, the detailed description, the drawings, the claims, the gene sequence information, which may also contain metadata of the patent data.

In this specification, the term, patent refers to any system that grants an exclusive right to a technological idea, such as an invention and utility model.

FIG. 1 is a diagram illustrating a technology literature searching system 10 according to an embodiment of the present invention.

Referring to FIG. 1, the technology literature searching system 10 may include a technology literature searching application apparatus 100 and at least one client terminal 200. However, this configuration is only a preferred embodiment for achieving the object of the present invention, some components may be added or deleted as necessary. In an embodiment, the technology literature searching application apparatus 100 and the client terminal 200 may communicate with each other via a network. The network may be implemented through a wired and/or wireless network such as a local area network(LAN), a wide area network(WAN), a mobile radio communication network, or a wireless broadband Internet(Wibro), which are well known in the related art. In addition, the technology literature searching application apparatus 100 may include software including executable instruction sets; hardware such as a microprocessor, a field programmable gate array(FPGA) or an application-specific integrated circuit (ASIC); or combination of the hardware and the software. The software and the hardware are not limited to being implemented as a single apparatus, but may be implemented as a cloud apparatus capable of mutual signal processing by combining resources through a network. Further, the technology literature searching application apparatus 100 is not limited to the software or the hardware, and may include, for example, a storage medium, a database, or one or more processors that may be addressed via a network or a bus line. Alternatively, it may have a configuration that includes other hardware apparatus, such as a general purpose computer system that may include or execute the processors. The functions provided by these elements may be implemented by more subdivided components, or may be implemented as one component that performs a specific function by combining a plurality of elements.

The client terminal 200 transmits search conditions, such as a search request for a target patent literature, search information required for searching the target patent literature, target field information or constraints described below, to the technology literature searching application apparatus 100, and is a computing apparatus that receives a result of a technology analysis of a target patent literature or a target patent. The information transmitted from the client terminal 200 to the technology literature searching application apparatus 100 is not limited to text, but may also be speech recognizable information, text recognizable graphic or document, but the present invention is not limited thereto. For example, when the information is a voice, text may be extracted from the voice. In the case of a graphic or a document, text may be extracted by parsing it using a known technology. For example, the graphic or document is an electronic file such as an electronic file of a patent publication, an electronic file of a treatise, a technology summary or a manual, and may be an electronic file of a non-limiting exemplary format which has an extension such as JPG, TIFF, PDF, DOC, HWP, TXT. A parser for extracting a search word from the graphic or document may be provided to the client terminal 200, the technology literature searching apparatus 100, or a third relay apparatus (not shown) between the technology literature searching apparatus 100 and the client terminal 200, but the present invention is not limited thereto.

The computing apparatus may include a notebook, a desktop, a laptop, and a smart phone, but is not limited thereto, and may include any electronic apparatus provided with a computing means and a communication means.

In an example, the client terminal 200 may be connected to the technology literature searching application apparatus 100 by using a web browser through the website information, for example, a uniform resource locator (URL), or to the technology literature searching application apparatus 100 or may access to the technology literature searching application apparatus 100 by using a program such as an app having a user graphical interface. The client terminal 200 may even access the technology literature searching application apparatus 100 through transmission through a facsimile or telephone, transmit information input by the user, and receive the results generated by the technology literature searching application apparatus 100 in the form of a text or a page which may be visualized. The type of information transmitted and received between the technology literature searching application apparatus 100 and the client terminal 200 may be text, voice, or image of document and video information, as described above, and is not limited to them. The user graphical interface may be implemented by the programming languages such as HyperText Markup Langauage (HTML), Visual Basic Scripting Edition (VBScript), JavaScript™, Extensible Markup Language (XML), Extensible Stylesheet Language Transformations (XSLT™), Asynchronous JavaScript and XML (AJAX), Java™, Java™ Foundation Classes (JFC), which are enumerated as non-limiting examples, or a programming method, and transmission and reception between the technology literature searching application apparatus 100 and the client terminal 200 may be performed. In addition, the transmission and reception of information between the technology literature searching application apparatus 100 and the client terminal 200 are not limited to a connection method through a web browser and an app, and the connection method may be a messaging service such as a telephone, a facsimile, or a messenger as described above, app plug-ins installed in apps, or the application programming interfaces (APIs), but the invention is not limited to them.

In an example, when there are a plurality of client terminals 200, the client terminals 200 may exchange information and cooperate with each other so as to provide a collaborative working environment among users of the client terminal 200. In addition, the technology literature searching application apparatus 100 may jointly provide a result obtained according to the information received from each client terminal 200 to the cooperating client terminal 200.

The technology literature searching system 10 may be connected to a database unit (not shown) for searching or acquiring treatise data, patent literatures, or a combination thereof through a network or a bus. The treatise data and the patent literatures may be stored in one database unit or may be separately stored in the treatise database unit including the treatise data and the patent database unit including the patent literatures. In the present specification, the term, “database unit” may refer to not only a storing place, but also a database server for managing stored information and the storing place itself depending on the context as well as the storing place. These database units may include an internal database included as a component of the technology literature searching system 10, an external database accessible through a network, or a combination thereof. These database units may include patent data databases, portfolio databases, user databases, mapping databases, and analysis databases, and the database units may also be implemented in various forms such as relational databases, centralized databases, distributed databases, object-oriented databases, or flat databases. The data in the database unit may be organized as a table having columns and rows. Each column of data may have a data type. The data type may include, for example, numeric data type, text data type, graphic data type, multimedia data type, or container data type, but the present invention is not limited thereto. The database may be the commercial treatise websites such as Web of Science, Scopus (https://www.scopus.com), NSDSL (www.ndsl.kr), Google Scholar (https://scholar.google.com), or crossreference (hups://www.crossref.org/), which may search the treatise data; or/and a database of commercial websites such as USPTO Patent Database, Espacenet, WIPO, or KIPRIS, or commercial websites, such as Delphi, or WIPS, where you may search for patent literatures; or a commercial patent website such as the WIPO patentscope. The external database is periodically or non-periodically downloaded and be processed into a dedicated data structure and stored in the internal or external storage or database of the technology literature searching application apparatus 100, or connected to the application apparatus 100 by a network for real-time access, so that the treatise data and/or patent literatures may be provided.

The database server of the database unit may receive a request from the technology literature searching application apparatus 100 or the client terminal 200 through a database connection inside or outside the database unit. The database connection may be a connection between the application apparatus 100 or the client terminal 200 and the database server, which facilitates communication including a database request and response. The request may be a database request (eg, a database query). The request may include a request for triggering a procedure previously stored in the database unit, or a request for data stored or referenced in the database unit itself. The database unit may be organized data set as a relational database, an object oriented database, or a collection of data organized as an ad hoc database.

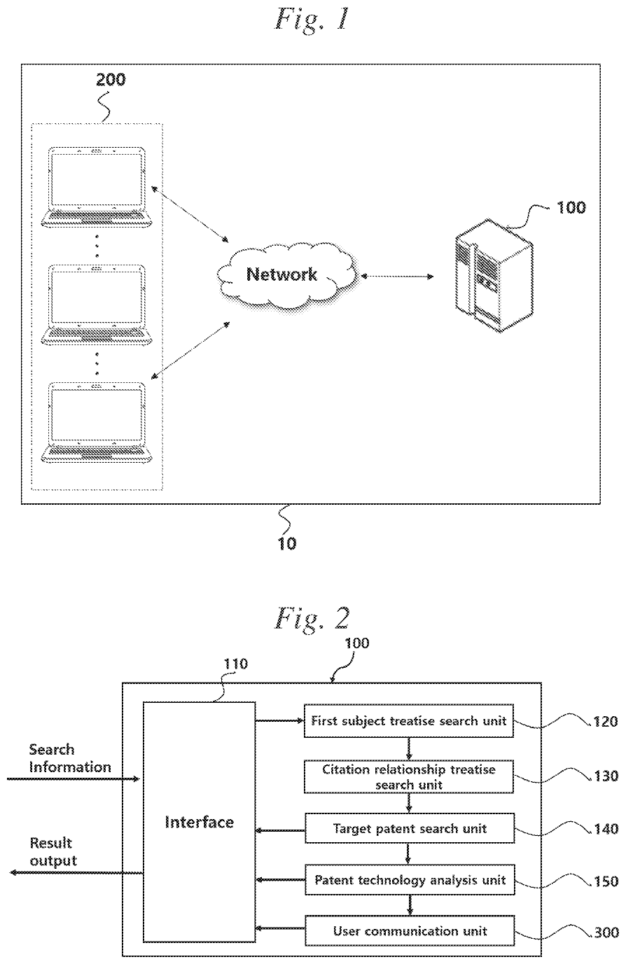

FIG. 2 is a diagram illustrating a technology literature searching application apparatus 100 according to an embodiment of the present invention.

Referring to FIG. 2, in an example, the technology literature searching application apparatus 100 may include an interface unit 110, a first subject treatise search unit 120, a citation relationship treatise search unit 130, and a target patent search unit 140. The ‘unit’ may include a unit implemented by any one of hardware or software or a combination thereof, and the unit may be realized by singular or plural hardwares, or singular or plural softwares. The units are not meant to be limited to software or hardware, and the units may be stored in a storage medium or additionally play other processors. For example, the units may include the elements such as object-oriented software components, object-oriented software components, class components, and task components; and processes, functions, properties, procedures, subroutines, segments of program code, drivers, firmware, microcode, circuits, data, databases, data structures, tables, arrays, and variables.

In an example, the interface unit 110 may receive search information from the client terminal 200. The search information may include technology keywords that may specify and search technology for a first subject treatise or a prior art, and the technology keywords may include have various combinations by using the operators such as “and operator”, “or operator”, “not operator” or “adjacent word operator”. Alternatively, the search information may be interpreted to include a combination of these operators. For example, the adjacent word operator may set number of words included between two words.

The search information may include at least any one of the bibliographic information such as identification information of the treatise, an author, or a related research institution (hereinafter abbreviated as “institution”) that the author belongs to, or cooperates with or sponsors the author in relation to the research topic of the treatise; or the issuing institutions. Specifically, the search information may include at least one or more of the author (in this specification, the term, ‘author’ refers to single author or at least one of the co-authors, if there are co-authors), the first author of the authors, the corresponding author, the institution of the author or the first author, links of the treatise site, abstracts, keywords, a main text, information on collaborative or sponsoring organizations, open researcher and contributor IDs (ORCIDs), conferences, journal titles, publication dates, digital objects identifier(DOI), an international standard serial registration number(ISSN), or a CAS registration number.

The first subject treatise search unit 120 may search for the first subject treatise data from the search information. In an example, the first subject treatise search unit 120 may extract treatise data including at least one or more of the search information among treatise data of a database unit(not shown), list them according to the order of amount including the search information, and display them in the search results. In other example, the search information may be received with classifying every search item, and it may be determined whether the search information matches the treatise data for every search item. In other example, when the search information is received from the user, the first subject treatise search unit 120 may automatically classify the search information and assign it to an appropriate search item. For example, when the search information is a registered author's name, the search information may be assigned to an author among search items, and when the search information is a name of a journal, the search information may be assigned to a name of a journal among search items. When the search information includes a technology keyword, the search information may be assigned to a keyword related to the technology among the search items.

In an example, when the first subject treatise data is published by the co-author, the first subject treatise search unit 120 may search author within a predetermined rank among the co-authors, and the predetermined rank may be received from the client terminal 200, or for example, according to a variable setting value based on a co-author within second rank, a search restricted only for authors within second rank may be performed. In addition, the information of the affiliated institutions and sponsoring institutions may include the names, unique numbers, addresses, or names of representatives of the organizations. The names of the conferences and journals may be searched by their full name or abbreviation in English.

The citation relationship treatise search unit 130 obtains target treatise data having a citing or cited relationship with the predetermined first subject treatise data, or target treatise information about the target treatise data, from the citing or cited relationship information of the first subject treatise data. The first subject treatise data related to the search information input to the client terminal 200 may be plural, and the predetermined first subject treatise data among the first subject treatise data may be selected by a user. Alternatively, the predetermined first subject treatise data may be determined according to a predetermined criterion. As a non-limiting example, the predetermined first subject treatise data may be listed-up as a treatise disposed on the top of a search result screen among the first subject treatise data searched by including the largest number of the search information. Alternatively, the predetermined first subject treatise data may be a treatise written in a journal having the highest impact factor (IF) among the first subject treatise data, or a treatise with the highest number of citations.

In an example, the citation relationship treatise search unit 130 is connected to the citation relationship database unit (not shown) for storing a citing and cited information between a plurality of the treatise data as a metadata in the form of a non-limiting example, so that the target treatise data or the target treatise information of the target treatise data be searched. In an example, the target treatise information is a piece of information included a target treatise data extracted from the target treatise data firstly obtained, or may be directly extracted by the citation relationship treatise search unit 130 as the target treatise data. To this end, in the citation relationship treatise search unit 130, the citation relationship database unit which extracts the target treatise information from the target treatise data may be a commercial treatise website such as Web of Science, Scopus, Google Scholar, or crossreference (https://www.crossref.org/), or a database stored in an external storage or an internal storage for storing the citing or cited information of the technology literature searching application apparatus 100. For example, when the citation relationship database unit may be accessed through the Internet in the case of the commercial treatise website, it may be connected via an Internet, and when provided from an external storage, it may be connected through a network. When present in the internal storage, it may be connected via a wiring system such as a bus. A detailed description of the citation relationship treatise search unit 130 may refer to the disclosure of the database unit if there are no contradictions.

Since the target treatise data is a treatise citing or cited by the first subject treatise data, it is clear that the author or sponsoring institution of the target treatise data is interested in the technological content of the first subject treatise data. In connection with the technological content of the target treatise data, for example, it is supplementary, improved, revised technology, or design-around, and refuting technology for the technical content of the first subject treatise data, or a technology that replaces some or all of elements of the technology content. Therefore, the technological content of the target treatise data has its technological significance. In addition, according to an embodiment of the present invention, some advantages are provided as follows. That is, the treatise of another person expressing the technology of interest may be searched in another term by using a search method or a route to search for a target patent through a treatise-to-treatise citation relationship rather than a patent-to-patent citation relationship. Further, it is possible to search for the important patent literatures that are liable not to be searched due to differences of terms by additionally using the terms of the treatises of other person within the citing or cited relationship as a search keyword, or by finding a patent literature or a target patent to be described later,

In an example, the citation relationship database may include information on the impact factor (IF) of each of the plurality of treatise data. The impact factor is an index for evaluating the importance of the journal by analyzing the number of times the journal containing the concerned treatise data to be cited, and the impact factor may be a criterion for evaluating the academic or industrial value of the treatise data. For example, the citation relationship treatise search unit 130 may assign weights to the treatise data included in the journal having a high impact factor among the searched target treatise data, and the weight may be a criterion for evaluating the importance of the searched target patent literature.

In an example, the citation relationship treatise search unit 130 may assign a weight to a target patent literature to be searched according to the number of citation times of the first subject treatise data or the target treatise data. In an example, a weight generated by evaluating each treatise data according to the number of citations may be stored and provided in the citation relationship database unit 130, and the citation relationship treatise search unit 130 may generate information about the weight based on the treatise data and the count of citation counts provided from a commercial treatise website. The weight may be given by converting a predetermined number of citations into a predetermined weight. For example, when the number of citations is 10 times, a weight of 1 may be assigned.

In other example, the relative weight may be given according to the number of citations of the first subject treatises and/or target treatises included in the search result. The first subject treatise data may be arranged according to the order of the number of citations thereof, and the weight may be calculated by assigning a weight of 9 to less than top 10%, and assigning a weight of 8 to more than the top 10% and less than top 20%. In other example, the weight may be calculated by using an average value and a standard deviation of the number of citations of the first subject treatise data and/or target treatise data included in the search result, and the standard deviation may be appropriately controlled. This is a non-limiting weight estimation method, and various known technology s for weighting may be referred to.

According to an embodiment of the present invention, the number of citations of the first subject treatise data and/or the target treatise data used as an intermediate search parameters for searching the target patent literature is evaluated and a weight is assigned to the target patent literature, so that it's easy to sort out the prior art having high importance, and the the technologies considered with very high importance in academia, attracting many researchers' attention and being cited by many researchers while having very high patentability and high possibility in a view of commercialization may be sorted out by only one search. In addition, the higher weighted patents among the target patent literatures enter into a research phase beyond a new idea or concept level, and are the patents acquired by combination of high academic knowledge and research know-how, and the weight of the target patents may serve as an indicator to quantify value evaluation, commercialization evaluation or development possibility of the technologies of the searched target patent literatures.

In an example, the citation relationship treatise search unit 130 may weight the target patent literature according to a citation position where the target treatise data cites the first subject treatise data, or the target treatise data is cited by the first subject treatise data. The citation position may be any one or more of an abstract, an introduction, a body, a discussion, an experimental example, or a measurement example. Abstract and/or introduction parts in treatises are portions in which technology flow of the technological field in which the concerned treatise is included, problems in the technological field, improvements, prior art fields, neighboring technologies or competitive technologies are described. Part of discussions, conclusions, or applications is the part in which discussion, analysis, or application of the results of the study is described, and the experimental and/or measurement examples describe the measuring equipment, data, types of reagents, or experimental methods used. Therefore, the relevance to the technology described in the target treatise and the first subject treatise is the highest in the abstract, summary, discussion, experimental example, measurement example conclusion or application. The introductory part cites the treatises related to the prior art or adjacent technology, and thus, the relevance to the technology described in the treatises by may be lower than the preceding abstract, summary, discussion, conclusion, or application. By way of example, three points may be given for discussion, two points for experimental example and/or measurement, and one point for abstract and introduction. The aforementioned weights are only non-limiting examples, and the numerical value of the weights, or the order of the weight size may be changed.

According to an embodiment of the present invention, by displaying the weights in the target patent literatures together or by arranging the searched target patent literatures in the order of the weight, the target patent literatures highly related to the search information may be firstly classified, and the less relevant target patent literatures may be placed in a subordinated list according to the removal or search results to select highly accurate target patent literatures. When the patent search is extended by using the backward or forward citation relationship of the treatises, it is possible to search patent literatures in an overly wide technological field as compared to searching patent literatures using only the search keyword information, and in this case, much time for reviewing the searched patent literatures may be required and thus, it becomes very inefficient. Therefore, the technology literature searching application apparatus 100 with high accuracy may be provided by quantifying the relation between the search information and the target patent literature based on the weight.

In an example, when a treatise data directly backward/forward citing the predetermined first subject treatise is defined as a first generation backward/forward citation treatise data, and a treatise data indirectly backward/forward citing the predetermined first subject treatise by backward/forward citing the first generation backward/forward citation treatise is defined as a second-generation backward/forward citation treatise data, a treatise data indirectly backward/forward citing the predetermined first subject treatise by backward/forward citing n-1th generation backward/forward citation treatise as n-1th generation backward/forward citation treatise data, and a treatise data indirectly backward/forward citing the predetermined first subject treatise by backward/forward citing nth generation backward/forward citation treatise as nth generation backward/forward citation treatise data, the citation relationship treatise search unit 130 may further include a citation generation setting unit (not shown) to designate a predetermined n value for limiting search result of a target treatise data and the target treatise is set to be the nth generation backward/forward citation treatise data. The predetermined “n” value may be a natural number greater than 1. The predetermined “n” value may be set as a default value, or the value may be received from the client terminal apparatus 200, changed, and set to any value. The technology literature searching application apparatus 100 may automatically set an appropriate value. In addition, the value “n” may be automatically set such that the target treatise data may have the search results, for example in less than 200.

Target treatise information may be extracted from the target treatise data. The target treatise information may include at least one or more of title, author, a first author of the treatise, affiliated institution of the author or the first author, a link to a treatise site, abstract, keywords, body, information of sponsoring organizations, ORCID (open researcher and contributor ID), society, a name of journal, publication date, digital object identifier (DOI), international standard serial registration number ISSN), CAS registration number, automatic recommendation keyword added by the citation relationship treatise search unit 130, a synonym of the automatic recommendation keyword, keyword from deep-learning or artificial intelligence(AI), or a frequently used word of the treatise data. In other example, when the target treatise data is published by the co-authors, the information of all the authors in the co-author, or the information of author having a predetermined rank or less may be added in the target treatise information. In addition, the information of the affiliated organizations and sponsoring organizations may include the names, unique numbers, addresses, names of representatives of the organizations. The names of the conferences and journals may be stored in full names or abbreviations, and may or may not distinguish between uppercase and lowercase letters.

In an example, the citation relationship treatise search unit 130 may extract keywords of the word group unit by performing morphological analysis for the target treatise data, and the keywords of the word group unit, may be extracted by a method such as a complex system algorithm, a neural network, an ontology, a thesaurus, or a word net, which are non-limiting examples. In other example, the keyword may be extracted from the target treatise data, and the target treatise information may be obtained based on the frequency of use of the keywords, the importance thereof, and the relationship between the keywords. The frequency of use of the keyword may be the number of times of use of the keyword in the entire treatise data, and the importance of the keyword may be calculated based on the number of target treatise data related to the keyword, and the number of times when the target treatise data cites forward/backwardly. In addition, the relationship between the keywords may be defined based on whether the keyword is used in the same treatise or not, and an affinity among the keywords. In an example, the citation relationship treatise search unit 130 may generate second treatise information including the automatic recommendation keyword or a synonym of the automatic recommendation keyword. In other example, the target treatise information may be ranked through a deep-learning, artificial intelligence (AI), or information processing using frequent words, importance, or a predetermined number of prior order significant search keywords may be output to the client terminal 200, or the search keywords may be added to perform a patent literature search.

In an example, the target patent search unit 140 may search target treatise data or target patent literatures associated with the target treatise data. The target treatise data or the target patent literatures associated with the target treatise data may include at least one of the target treatise information. The target patent literature may include a published, withdrawn, expired, abandoned, invalid, rejected patent application, registered patent, or a combination thereof. In addition, the target patent literature may be searched on a web site in online or searched in a database stored in a local storage apparatus, or may be searched by accessing an external server connected to the technology literature searching application apparatus 100 through a network.

In an embodiment, the target patent search unit 140 may search a target patent literature related to all of the target treatise data, or search a limited target patent literature related to a predetermined target treatise literature determined by a predetermined criterion or a user's selection of the target treatise data. For example, the client terminal 200 may receive information of the user's selection on the predetermined target treatise data from the user, or may set the target treatise data having the highest weight among the target treatise data as the predetermined target treatise data. According to the exemplary embodiment of the present invention, when the treatise having the highest weight is searched as the predetermined target treatise data, the target treatise data most relevant to the searched technology or the search information, or the target treatise data with the highest importance among academia or researchers can be automatically selected. Thus, patent literatures which have high accuracy and disclose state-of-art technology in the related art may be quickly and selectively searched.

In an embodiment, the target patent search unit 140 may search for a target patent literature including at least one or more of the target treatise information in a target field initially set or selected by a user. For example, when the target field is “total claims”, the target patent search unit 140 may select the patent literatures including at least one or more of the target treatise information in the total claims among patent literatures, as a target patent literature. The target field may be automatically set by the technology literature searching application apparatus 100, set to a default value by the user, or selected by the user through the client terminal 200 at the time of searching. For example, the target field may be an inventor, an applicant, a current right owner, a combination of title+a summary+all claims, an independent claim, a detailed description, an index word, or a combination thereof. When the target field is set as an inventor, an applicant, or a current owner of a patent right, a company, a researcher, or a research institute which is applying for patent applications in a technological field of a search target technology, an adjacent technological field of the technological field, or a competitive technology field may be searched. In addition, it is possible to grasp the latest technologies and trends of patent technologies for which the companies, researchers or research institutes are filing the patent applications. In addition, when the target field is set as a technology content item such as the entire claim, the independent claim, or the title+summary+all claims, target patent literatures related to a technology content described in the target treatise may be searched. In particular, there are many cases where a patent application related to the research content described in recently published treatise is filed, but it is difficult to confirm the reference relationships between the patent application and the published treatise because the citation relationship between the treatise and the patent application is not indicated. According to an embodiment of the present invention, it is possible to easily search for patent literatures related to the treatise or derived from the contents of the treatise by appropriately setting the target field.

In other example, the target patent search unit 140 may search for the patent literatures requesting a publication exception assertion (or claiming a grace period) for the target treatise data as target patent literatures. The target treatise data and the publication exception assertion database of the target patent literature may be provided by the Governmental Patent Office, stored in a database, or stored in a server or storage inside or outside the patent application apparatus. According to an embodiment of the present invention, if the publication exception assertion database is used, it may be possible to search the patent literature with higher reliability as compared with when searching by keywords. Detailed description of the above-mentioned publication exception assertion database may refer to the above-described disclosure with respect to the database portion of the present invention, which does not limit the present invention.

In an example, the target patent search unit 140 may search a patent literature by applying at least one of the target treatise information in a target field and an additional keyword in the target field as the target patent literature. The additional keyword may be input from the user through the client terminal 200. According to an embodiment of the present invention, when the technological field of the patent literatures including at least one of the target treatise information is widely distributed and therefore there are a large number of noise data that are not related to the technologies to be searched, the noise data may be removed by using the additional keyword, so that it is possible to quickly search for patent literatures related to the search target technology.

In an example, the target patent search unit 140 may access the patent database unit to search for the target patent literature. The patent database unit (not shown) may be a public information website such as USPTO Patent Database, Espacenet, WIPO, or KIPRIS, or a commercial web site such as Delphi, or WIPS, or a storage and/or database provided inside or outside the technology literature searching application apparatus 100 that stores information for patent search by extracting information of these databases in advance in real time or periodically. The present invention is not limited to this.

In other example, the patent database unit may further include individual patent information matched to each patent literature of a plurality of patent literatures. Individual patent information may include documented information to find a plurality of patent literatures more quickly and accurately. For example, the individual patent information may include patent literature identification information such as an application number, a publication number, an international application number, an international publication number, a registration number, or a combination thereof of each of the patent literatures. It may be matched to a file of patent literatures. In addition, the individual patent information may include a data model, object-oriented metadata or index for storage according to the physics, concept, distribution or a combination thereof for documents or images of a plurality of patent literatures, and the present invention is not limited to them.

The plurality of patent literatures and individual patent information are stored in the internal storage of the technology literature searching application apparatus 100, and are connected via a bus. Alternatively, they may be stored in an external storage of the apparatus 100 and are connected via a network, or they may be provided through Internet when they are stored in the web sites. In addition, the plurality of patent literatures and individual patent information may be updated in the concerned storage automatically or manually, and periodically or non-periodically.

In an example, the individual patent information may be matched to each patent literature, and each patent literature may be identified according to identification information such as application number, publication number, international application number, international publication number, registration number or a combination thereof. The individual patent information may be matched with the patent literature identification information. The individual patent information may include keywords, and synonyms, alternatives, and equivalents of the keywords related to at least one of the purpose of invention, background art, claims, effects of the invention, detailed description for carrying out the invention, an application date, an applicant or inventors of the plurality of patent literatures.

In an example, in connection with the objects, background art, claims, effects of the invention, the specific details, the keyword may be extracted in a limited way that it may be set to a predetermined number of times. The predetermined number of times may be set for each field of patent information or may be set for the entire patent literature. In other example, a plurality of keywords are extracted from all of the patent literatures, in connection with the extracted plurality of keywords, a ranking is assigned to the extracted plurality of keywords according to the number of times included in each of all the patent literatures, and the keywords having a predetermined rank or more among the keywords arranged according to the ranking order may be included in the individual patent information. In other example, the predetermined rank order may be set automatically by the technology literature searching application apparatus 100 or manually by information received by the client terminal 200.

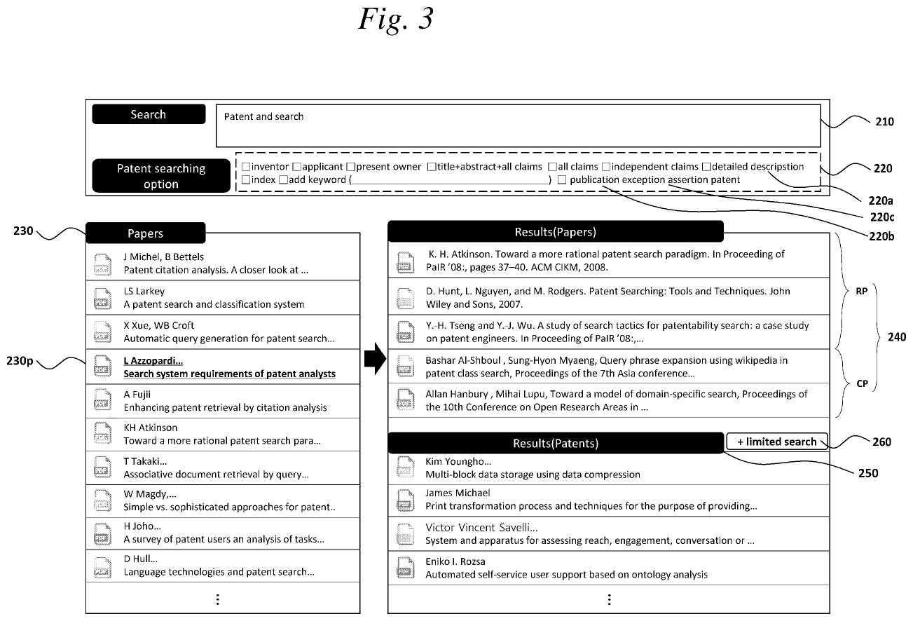

FIG. 3 is an output screen displayed on the client terminal 200 by user communication unit 300 of the technology literature searching application apparatus 100 according to an embodiment of the present invention.

Referring to FIG. 3, in an example, the user communication unit 300 transmits the identification information of the searched patent literatures, original file, treatise data, the information of the patent literatures, or a combination thereof to the client terminal 200 or another server to output the results. The user communication unit 300 may be a mobile communication chip (not shown), a wired communication chip (not shown), a Wi-Fi chip (not shown), a wireless communication chip (not shown) or a combination of them for communicating with the client terminal 200 or another server. The searched treatise data or a patent literature may include the first subject treatise data, the target treatise data or the target patent literature.

In an example, the search information may be input to the search information input unit 210 of the client terminal 200. For example, the search information is shown as “patent search”. Since the search information includes “patent” and “search”, the search information may be connected with the “and” operator. The first subject treatise search unit 120 may search for the first subject treatise data including both “patent” and “search” and may output it to the first subject treatise output unit 230, according to the search information.

In an example, as for the first subject treatise data of the first subject treatise output unit 230, the treatise data having high weight may be arranged on an upper side of searched result according to the number of times of citation of the first subject treatise data, as described above in FIG. 2. In the first subject treatise output unit 230, any one among the first subject treatise data may be selected and determined as the predetermined first subject treatise data 230p. In an example, the predetermined first subject treatise data 230p may be selected by a user on the client terminal 200 or may be determined according to a predetermined criterion.

The citation relationship treatise search unit 130 may search for target treatise data having a backward/forward citation relationship with the entire subject target treatise data or the predetermined first subject treatise data 230p, and output the target treatise data to the target treatise output unit 240. Some of the target treatise data may be treatise data (RP) citing the target treatise data, or some others may be the treatise data cited by the target treatise data, i.e., the treatise data (CP) to be in cited in the target treatise data. The target treatise output unit 240 may separate and output the treatise data (RP) citing the target treatise treatises and the cited treatise data (CP). In other example, in connection with the target treatise data, a document data having a high weight may be arranged on the upper side of searched list according to the count of citations described above in FIG. 2. Alternatively, while the treatise data (RP) citing the target treatise data and the treatise data (CP) cited by the target treatise data are arranged separately, the treatise data having a high weight may be disposed at the upper side of searched list.

In an example, the target patent search unit 140 may search for target patent literature and output target patent literature to the target patent output unit 250. The target patent search unit 140 may search for a target patent literature related to all of the target treatise data, and may search for target patent literatures related to a predetermined target treatise data among the target treatise data. In other example, among the treatise data displayed on the target treatise data output unit 240, the treatise data determined by user's selection may be determined as the predetermined target treatise data. Alternatively, the predetermined target treatise data may be determined according to a predetermined criterion.

In an example, information such as the original text of the target patent literature, the application country, the application number, information on whether a patent is registered or published, the date of application, the title of the invention and the applicant's information is displayed may be displayed as the information of the target patent literatures on the client terminal 200, and the type of the display information may be changed according to a search result display request received through the client terminal apparatus 200. In other example, the above information may include a full text of publication, a full text of publication, registration details, priority information, and integrated administrative information. For example, the integrated administrative information may be an application, a correction notice, and a notification of an applicant information change. In addition, the target patent literature may be specified by at least one or more of an application number, a publication number, an international application number, an international publication number or a registration number.

As described above, the target patent search unit 140 may search for a target patent literature including at least one or more of the target treatise information in a target field initially set or selected by a user. The target patent search unit 140 may search a target patent literature based on search conditions received from the patent search option unit 220, and the patent search option unit 220 may include a target field selection unit 220a for selecting target fields, a keyword addition unit 220b for receiving an additional keyword, or a patent selection unit 220c for a publication exception assertion. The target field selection unit 220a may include a display of a plurality of target fields and a plurality of selection boxes allocated to each target field. In addition, a keyword addition unit 220b may be provided to select patent literatures including keywords added from a user based on a keyword addition item, among patent literatures related to target treatise information, and a selection box may be also provided, so that a user may determine whether addition of a keyword is allowable or not. In addition, when the selection box of the patent selection unit 220c for a publication exception assertion is checked by the user, the target patent literatures to which a publication exception assertion is applied in response to the target treatise data may be output to the target patent output unit 250.

In an example, the target patent search unit 140 may further include a first restriction search unit (not shown) or a second restriction search unit (not shown). The first restriction search unit may search only for the target patent literature limited to the applications filed within a grace period of a publication exception assertion. For example, according to the article 30 of the Korean Patent Act, if a patent application is filed within 12 months from the date of publication, if it is disclosed by a person who has the right to obtain a patent or against the intention of the person who has the right, when judging novelty and inventiveness of an application, the publication before filing the application is not considered. Accordingly, when only the target patent literature filed within the grace period of a publication exception assertion from the publication date of the first subject treatise data or the target treatise data is searched, the patent literatures having high degree of relevance and high similarity with respect to the first subject treatise data or target treatise data may be searched in a limited way. In other example, the grace period of a publication exception assertion varies from country to country. That is, one year is designated as a grace period in Korea, and the United States; and six months in Japan, China, and Europe. Accordingly, the technology literature searching application apparatus 100 may set the grace period of a publication exception assertion differently for each country.

The second restriction search unit may search for a target patent literature limited to patent applications filed within a previous period limit or a subsequent period limit based on the filing date or the publication date of the target treatise data. In an example, the technology literature searching application apparatus 100 may receive a search condition for the latest day and the last day of the filing date of the target patent literature from the client terminal 200, and may receive a search condition for such as the filing date or the publication date of the target treatise data, a previous period limit and a subsequent period limit may be received. Also, for example, the technology literature searching application apparatus 100 may recommend the best period limitation condition and display the same on the client terminal 200. In addition, without limitation, the technology literature searching application apparatus 100 may search for the target patent literature on the basis of a search condition that the target treatise data is published within the period in which the priority patent literature may be claimed and/or the publication time of the target patent literature.

In an example, the limitation search condition unit 260 that may receive a period limitation condition (for example, Jan. 1, 2019 to Apr. 30, 2019) on the search screen displayed on the client terminal 200 may be displayed. The user may enter a period limitation condition to the limitation search condition unit 260, set a grace period of publication exception assertion, or select a limitation period recommended from the technology literature searching application apparatus 100. This is a non-limiting example, and as for the type of the limitation search condition unit 260, all kinds of known technology s that may set the period search condition may referred to.

Referring back to FIG. 2, the technology literature searching application apparatus 100 may further include a patent technology analysis unit 150. The patent technology analysis unit 150 may generate technology analysis information including at least one or more of change state of an applicant of the target patent literature, a joint application, ownership transfer, an information about whether a license is established or not, succession identification information of an application right, co-applicant's identification information, assignee identification information, licensee identification information, remaining term information, an application date, the number of family applications, a country information, and a lawsuit. In an example, the patent technology analysis unit 150 may evaluate the importance of the target patent literatures or a degree of the relationship with the search target technology with reference to the weights assigned to the target patent literatures described above in FIG. 2. In recent years, a huge amount of patent applications or patents have been produced due to the patent encouraging project of the public organizations, and it is important to select the technologies having future values, such as the technologies that are not currently used, among the patent applications or patents, but have high future values, and source technology that may be utilized later in other industries. According to an embodiment of the present invention, various aspects of patent technology analysis as described above may be performed to generate useful information for selecting the technologies having future values.

The data for calculating the technology analysis information may be provided through a homepage of the Intellectual Property Office, a commercial patent database, or a public database. In an example, the technology analysis information is periodically updated on a server linked with the technology literature searching application apparatus 100, and may be connected with the homepage of the Intellectual Property Office, commercial patent database or public data portal via on-line and then, may be received from them.

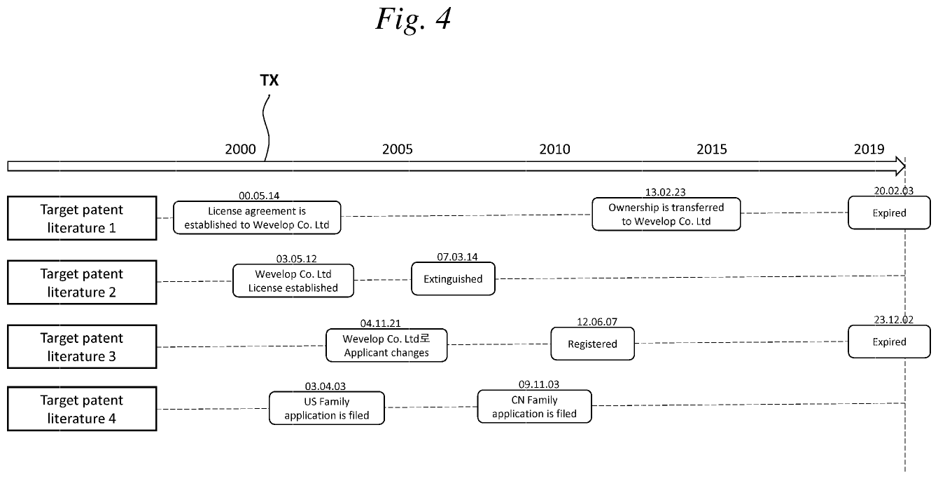

FIG. 4 is a diagram illustrating a technology analysis method of the patent technology analysis unit 150 according to an embodiment of the present invention.

Referring to FIG. 4, in an example, the patent technology analysis unit 150 may configure the technology analysis information in time series or time progress. The technological analysis information such as establishment of a license, ownership transfer, or change of applicant of each target patent literature may be represented in time series on the time axis TX. The target patent literatures may be all of the target patent literatures searched by the patent search unit or may be some of the target patent literatures selected by the user. FIG. 4 is an example listing technology analysis information and does not limit the present invention. In addition, the technology analysis information may be output on a search result screen acquired through the client terminal 200, information stored in a website account for executing the technology literature searching application apparatus 100, a document file such as a word or pdf format, or a file format which allows a large amount of data be handled, such as worksheet, Excel or a patent map. In addition, in an example, the technology analysis information may be provided as a visualized format of a graph, pie graph or network.

In an example, the patent technology analysis unit 150 may transmit the technology analysis information to the user communication unit 300, and the user communication unit 300 may output the technology analysis information in time series through the client terminal 200. The detailed description of the output method of the client terminal 200 may refer to the disclosure described above in FIG. 1.

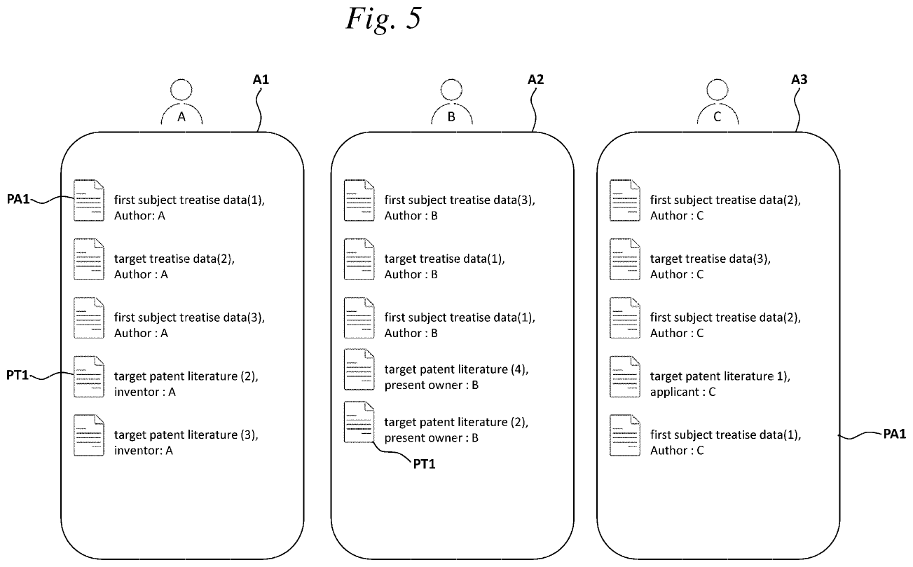

FIG. 5 is a diagram illustrating an exemplary technology analysis method of the patent technology analysis unit 150 according to another embodiment of the present invention.

Referring to FIG. 5, in an example, the first subject treatise data, the target treatise data, or the target patent literature may be classified according to any one of the inventors, applicants, current owners, or affiliated institutions of the authors. The author of the treatise data is generally a researcher of the study, and an applicant of a patent application or a patent based on the treatise may be the affiliated institution or sponsoring institution to which the researcher belongs. In an example, the patent technology analysis unit 150 may determine whether the concerned persons or organization are the same researcher or the same organization, and may classify the patent literatures or the treatise data based on the respective same researcher or the respective same organization by referring to the author of the treatise data, the author's affiliation, the sponsoring institution of the treatise, information on the society or journal and the original applicant (if there is a change of an applicant) of the patent literature, an applicant, an initial owner, a current owner, or information about the inventor. The identification information for determining whether the person or organization is the same person or the same organization may include an email address, affiliation, a social security number, a name, or a business registration number. In other example, since there is a plurality of authors in a single treatise data, and a separate institution or sponsoring institution of the author exists, one patent literature PA1 may also belong to a plurality of classifications Al and A3, and one patent literature PT1 may belong to a plurality of classifications Al and A2.

According to the embodiment of the present invention, it is possible to select and analyze the technological fields to which a given researcher, a research institution, a research company, or a sponsoring institution has a keen attention, and to easily grasp the flow of research technology. Therefore, according to the present invention, in order to commercialize or evaluate the technology to be searched, an analysis platform for searching a research company or sponsoring institution closely related to the technology to be searched, or for searching a researcher or research institute researching the technology to be searched may be provided. In addition, it is also easy to determine whether the search target technology is being actively studied by a large number of researchers or is exclusively studied by one research institute.

In addition, according to an embodiment of the present invention, an optimal target patent literature may be obtained in order to generate the technology analysis information, such as the transfer of the technology of interest from the target treatise, the current status of disputes related to the technology of interest, commercialization portfolio strategy and commercialization strategy using the technology of interest. In particular, when there is a subjective difference in terms of the first subject treatise data and the author, affiliated organization and/or sponsoring institution of the target treatise, it may be considered that the first subject treatise data and the target treatise data are issued from competitive research groups or institutions, and the target patent literature detected from the target treatise data may be a patent literature of a competitive research group or institution. Therefore, by analyzing the patent literature of the competitive research group or institutions derived in this way, it is possible to obtain portfolio strategy and commercialization strategy through technology transfer status, dispute status, claim construction, in connection with the technology owned by the competitive research group or institution.

In an example, it may be a problem whether an author of the first subject treatise, or the target treatise and an inventor or an applicant of a target patent literature are the same person or institution or not. The author, the applicant or the inventor may be input in Korean or English, and the name input in the Hangul may be compared with the Korean name, and the name input in the English may be compared with the English names to determine whether the applicant and the inventor are the same person of the author or not. In other example, the Korean name may be converted into the English name as a basis of the English expression, and the full name or initials of the English name may be classified and stored as information indicating the same person. For example, when the Korean name is [symbol] , and the English name is Hong Gildong, information such as Hong Gildong, [symbol] , G Dong Hong, and GD Hong may be classified as information indicating the same person.

In an example, when the target treatise data refers to the first subject treatise data, the patent technology analysis unit 150 may classify the target patent literature as a competitive technology, and when the first subject treatise data is citing the target treatise data, the target patent literature may be classified as a technology liable to infringe on target patent literature. When the target treatise data is citing the first subject treatise data, it is highly likely that the technology of the target patent literature searched by the target treatise data is a competitive technology, a similar technology, or a design-around technology of the technology of interest of the first subject treatise data. When the first subject treatise data cites the target treatise data, the technology of interest may be likely to infringe the technology of the target patent literature. The target patent literatures may be classified according to a citation relationship of the first subject treatise data and the target treatise data to provide a direction for establishing a commercialization portfolio strategy of the technology of interest.

FIG. 6 is a diagram illustrating a technology literature searching application apparatus 100′ according to another embodiment of the present invention.

Referring to FIG. 6, in an example, the technology literature application apparatus 100′ may include an interface unit 110, a subject patent search unit 160, a second subject treatise search unit 120′, and a citation relationship treatise search unit 130 and a target patent search unit 140. As for the second subject treatise search unit 120′, the disclosure regarding the first subject treatise search unit 120 described above with reference to FIGS. 1 to 5 may be referred to if there are no contradictions. As for a citation relationship treatise search unit 130 and a target patent search unit 140, the disclosures described above with reference to FIGS. 1 to 5 may be referred to.

In an example, the subject patent search unit 160 may obtain the subject patent literature and the subject patent literature information about the subject patent literature from the search information. A detailed description of the search information may refer to the above disclosure in FIG. 2. In other example, the subject patent search unit 160 may receive both the search information and a search field assigned to each of the search information from the client terminal 200. The search information may be assigned to title, summary, independent claims, whole claims, detailed description, an index word, an applicant, an inventor, an agent, an IPC code, an application number, an application date, a publication number, a publication date, regislation number, or a combination thereof. The previously mentioned fields are non-limiting examples and various classifications that may be applied to patent literature search may be applied.

In an example, the second subject treatise search unit 120′ may search for a second subject treatise having the same author as the inventor or the applicant of the subject patent literature information. As for a detailed description of how to distinguish whether the author, the inventor or the applicant is the same or not may refer to the disclosure of FIG. 5. According to an embodiment of the present invention, it is easy to identify researchers interested in commercializing patent and technology or securing intellectual property rights in the technological field to which the search subject technology belongs by searching for the subject patent literatures including the search subject technology, and searching the second subject treatise data through the inventor or the applicant of the subject patent literatures. In addition, there is an advantage that technology may be searched without missing by searching the target patent for technologies that are likely to be missed through the treatise data related to the search subject technology when searching for a target patent literature.

In an example, the subject patent literature may include a patent literature obtained from the search information, or a patent literature having a citation relationship with the subject patent literature. For example, the subject patent literature may include the patent literatures searched from the search information, a preceding patent cited by the patent literatures, or a subsequent patent citing the patent literatures. The citation relationship of the patent literatures may be included in a patent database described later, or the target patent search unit 160 may extract the patent literatures stored in the patent database to form a database.

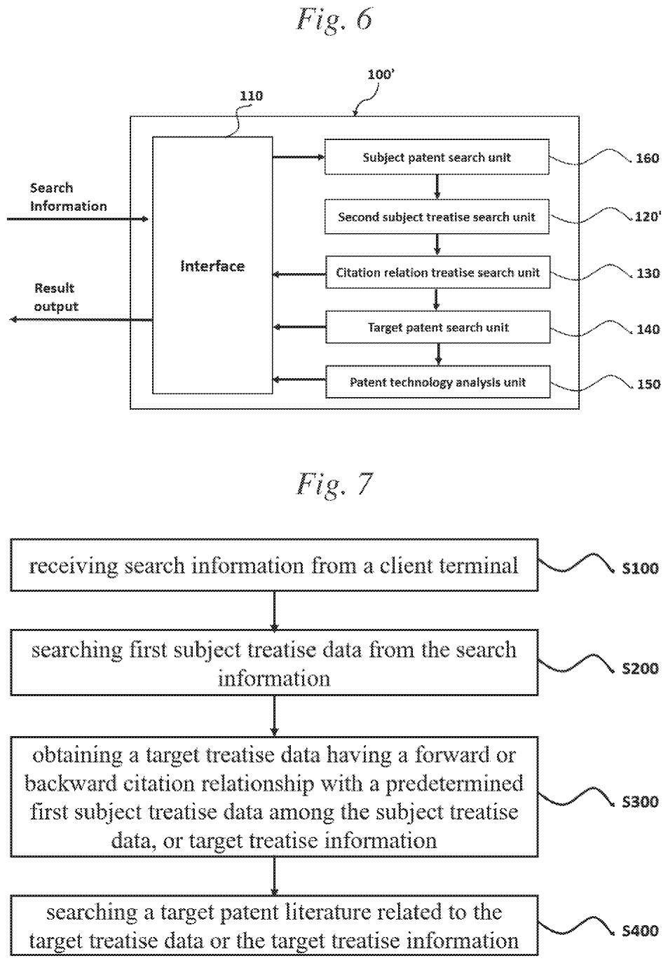

FIG. 7 is a flowchart illustrating a patent search method according to one embodiment of the present invention.

Referring to FIG. 7, the patent search method may be performed by a step for receiving search information from a client terminal. For example, the interface unit 110 receives the search information input by the user from the client terminal 200 (S100). When the search information is received, the first subject treatise search unit 120 searches and obtains the first subject treatise data based on the search information (S200). Subsequently, the citation relationship treatise search unit 130 obtains the target treatise data having a citation relationship with a predetermined first subject treatise data, or the target treatise information about the target treatise data, among the first subject treatise data (S300). The target patent search unit 140 searches for the target treatise data or the target patent literature related to the target treatise information (S400). In other example, the patent technology analysis unit 150 may further include a step for generating technology analysis information by analyzing the target patent literature. In connection with the detailed description of the patent search method, reference may be made to the disclosure of the technology literature searching application apparatus 100 illustrated in FIGS. 1 to 6.

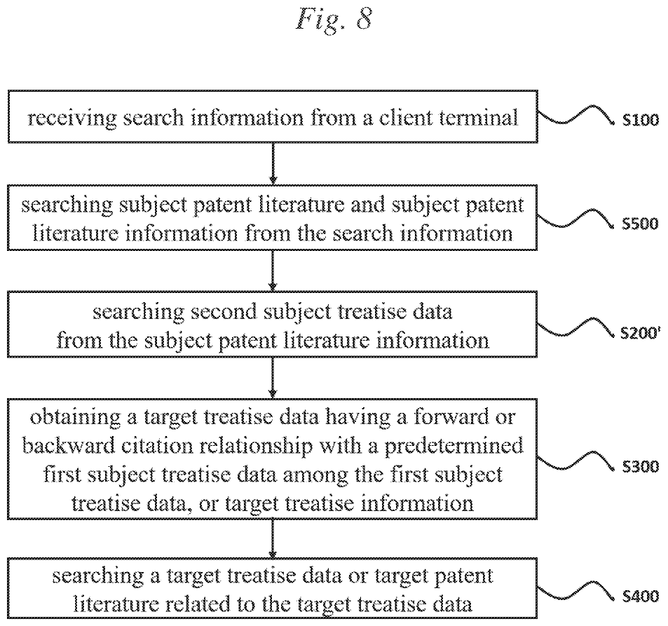

FIG. 8 is a flowchart illustrating a patent search method according to another embodiment of the present invention.

Referring to FIG. 8, each step of the patent search method according to an embodiment may be performed by the technology literature searching application apparatus 100′. The interface unit 110 receives the search information input by the user from the client terminal 200 (S100). When the search information is received, the target patent search unit 160 obtains the subject patent literature and the subject patent literature information about the subject patent literature from the search information (S500). Thereafter, the second subject treatise search unit 120′ searches for the second subject treatises related to the subject patent based on the subject patent literature information (S200′). Subsequently, the citation relationship treatise search unit 130 obtains the target treatise data having a citation relationship with a predetermined second subject treatise data, or the target treatise information about the target treatise data, among the second subject treatise data (S300). The target patent search unit 140 searches for the target treatise data or the target patent literature related to the target treatise information (S400). In connection with the detailed description of the patent search method, reference may be made to the disclosure of the technology literature searching application apparatus 100, 100′ illustrated in FIG. 1-FIG. 6.

Although the methods and systems of the present invention have been described in connection with specific embodiments, some or all of their components or operations may be implemented by using a computer system having a general purpose hardware architecture. The architecture includes one or more processors (eg, dual-core Intel® Xeon® processors)(a registered trademark), one or more output apparatus (eg, LCDs), one or more network interfaces (706), one or more input apparatus (eg, mouse, keyboard, touch sensitive display) and one or more computer readable media (eg, RAM, ROM, SDRAM, hard disk, optical disk, flash memory, etc.). These components may communicate and exchange data over one or more communication channels 710 (eg, buses), which may employ various hardware and software to facilitate the transfer of data and control signals between the components.

The term, “computer readable medium” includes, without limitation, non-volatile media (eg, optical or magnetic disks), volatile media(eg, memory), and transmission media, which are the arbitrary medium for providing the execution commands to the processor 702. Transmission media includes, without limitation, coaxial cable, copper wire, and optical fiber.

The present invention may be embodied as computer-readable codes on a computer-readable recording medium. The computer-readable recording medium includes all kinds of recording apparatus in which data that may be read by a computer system is stored. Examples of computer-readable recording media include ROM, RAM, CD-ROM, magnetic tape, floppy disk, optical data storage, and the like, and also include those implemented in the form of carrier waves such as transmission over the Internet. Further, the computer-readable recording medium is distributed into a computer systems connected via network so that the computer-readable code may be stored and executed according to a distributed system.

It will be apparent to those who have a common knowledge in a technological field to which the present invention belongs to, that the present invention described as above is not limited to the above-described embodiment and the accompanying drawings, and various substitutions, modifications, and changes are possible within the scope without departing from the technological concept of the present invention.

### EXPLANATION OF REFERENCE NUMBER

10: a patent search system

200: a client terminal

100, 100′: a technology literature searching application apparatus

110: an interface unit

120: a first subject treatise search unit

130: a citation relationship treatise search unit

140: a target patent search unit

150: a patent technology analysis unit

160: a subject patent search unit

210: a search information input unit

220: a patent search option unit

230: a first subject treatise output unit

240: an output unit

250: a target patent output unit

260: a limitation search condition unit

300: a user communication unit

What is claimed is:

1. A technology literature searching application apparatus using a treatise link search comprises,
an interface unit for receiving the search information from a client terminal;
a first subject treatise search unit for searching a first subject treatise data from the search information;
a citation relationship treatise search unit for obtaining a target treatise data having a forward or backward citation relationship with a predetermined first subject treatise data, or target treatise information about the target treatise data, from the citation relationship information of the searched first subject treatise data; and
a target patent search unit for searching a target patent literature related to the target treatise data or the target treatise information.

2. The technology literature searching application apparatus of the claim 1, wherein the predetermined first subject treatise is all of the first subject treatises or is determined by a predetermined criteria or a user's selection.

3. The technology literature searching application apparatus of the claim 1, wherein the citation relationship treatise search unit assigns a weight value to the target patent literature according to the number of times of forward citation of the first subject treatise or the target treatise data.

4. The technology literature searching application apparatus of the claim 1, wherein the citation relationship treatise search unit assigns a weight value to the target patent literature according to a citation position where the target treatise data cites or is cited by the first subject treatise data.

5. The technology literature searching application apparatus of the claim 4, wherein the citation position may be one or more of an abstract, an introduction, a discussion, an experimental example, or a measurement.

6. The technology literature searching application apparatus of the claim 1, wherein when a treatise data directly backward/forward citing the predetermined first subject treatise is defined as a first generation backward/forward citation treatise data, and a treatise data indirectly backward/forward citing the predetermined first subject treatise by backward/forward citing the first generation backward/forward citation treatise is defined as a second-generation backward/forward citation treatise data, a treatise data indirectly backward/forward citing the predetermined first subject treatise by backward/forward citing n-1th generation backward/forward citation treatise as n-1th generation backward/forward citation treatise data, and a treatise data indirectly backward/forward citing the predetermined first subject treatise by backward/forward citing nth generation backward/forward citation treatise as nth generation backward/forward citation treatise data,
the citation relationship treatise search unit includes further a citation generation setting unit to designate a predetermined n value for limiting search result of a target treatise data and the target treatise is set to be the nth generation backward/forward citation treatise data.

7. The technology literature searching application apparatus of the claim 1, wherein the target treatise information includes at least one or more of title, author, a first author of the treatise, affiliated institution of the author or the first author, a link to a treatise site, abstract, keywords, body, information of sponsoring organizations, ORCID (open researcher and contributor ID), society, a name of journal, publication date, digital object identifier (DOI), international standard serial registration number ISSN), CAS registration number, automatic recommendation keyword added by the citation relationship treatise search unit, a synonym of the automatic recommendation keyword, keyword from deep-learning or artificial intelligence(AI), or a frequently used word of the treatise data.

8. The technology literature searching application apparatus of the claim 1, wherein the target patent search unit searches a target patent literature including at least one or more of the target treatise information in a target field initially set or selected by a user.

9. The technology literature searching application apparatus of the claim 1, wherein the target patent search unit searches a target patent literature related to all of the target treatise data, or a target patent literature related to predetermined target treatise data determined by a predetermined criteria or a user's selection among the target treatise data.

10. The technology literature searching application apparatus of the claim 1, wherein the target patent search unit includes a first limit search unit configured to search limitedly the target patent literature filed within a grace period of a publication exception assertion of the target treatise data; or a second limit search unit configured to search limitedly the target patent literature filed within a previous period limit or a subsequent period limit from a filing date or publication date of the target treatise data.

11. The technology literature searching application apparatus of the claim 1, further comprising a patent technology analysis unit for generating technology analysis information including at least one or more of change state of an applicant of the target patent literature, a joint application, ownership transfer, an information about whether a license is established or not, succession identification information of an application right, co-applicant's identification information, assignee identification information, licensee identification information, remaining term information, an application date, the number of family applications, a country information, and a lawsuit.

12. The technology literature searching application apparatus of the claim 12, further comprising a user communication unit configured to output identification information of a searched treatise data or a patent literature, an original text file or the treatise data, information of patent literatures, or a combination thereof, and wherein the searched treatise data, and the patent literature include the first subject treatise data, the target treatise data or the target patent literature.

13. The technology literature searching application apparatus using a treatise link search comprising,
an interface unit for receiving search information from a client terminal;
a subject patent search unit for obtaining subject patent literature and subject patent literature information related to the subject patent literature from the search information;
a second subject treatise search unit for searching second subject treatises related to the subject patent from the subject patent literature information;
a citation relationship treatise search unit for obtaining target treatise data having a forward or backward citation relationship with a predetermined second subject treatise, or target treatise information about the target treatise data, from the citation relationship information of the searched second subject treatise; and
a target patent search unit for searching the target patent literature related to the target treatise data or the target treatise information.

14. The technology literature searching application apparatus of the claim 13, wherein the subject patent literature comprises a patent literature obtained from the search information or a patent literature having forward or backward citation relationship with the subject patent literature.

15. The technology literature searching application apparatus of the claim 13, wherein the search information is assigned to a title of a invention, summary, an applicant, a detailed description, an inventor, an IPC code, an application date, a publication date, a registration date, an application number, a publication number, a registration number, an agent or a combination thereof.

16. The technology literature searching application apparatus of the claim 13, wherein the second subject treatise search unit searches for a second subject treatise having the same author as the inventor or the applicant of the target patent literature information.

17. A patent search method using a treatise link search comprises,
a step for receiving search information from a client terminal;
a step for searching subject treatise data from the search information;
a step for obtaining a target treatise data having a forward or backward citation relationship with a predetermined subject treatise data among the subject treatise data, or target treatise information about the target treatise data; and
a step for searching a target patent literature related to the target treatise data or the target treatise information.

18. The patent search method using a treatise link search of the claim 17, wherein the step for searching the subject treatise data from the search information comprises,
a step for obtaining a subject patent literature or a subject patent literature information about the subject patent literature from the search information; and
a step for obtaining the subject treatise data related to the subject patent literature from the subject patent literature or the subject patent literature information.

19. The patent search method using a treatise link search of the claim 17, wherein the target treatise data or the target patent literature is displayed to a user in time series or time progress.

20. The patent search method using a treatise link search of the claim 17, wherein the target patent literature is assigned with a weight value according to a citation position where the target treatise data or the target patent literatures cites or is cited by the subject treatise data.
